(19) United States
(12) Patent Application Publication
(10) Pub. No.: US 2018/0252038 A1
(43) Pub. Date: Sep. 6, 2018

(54) PORTABLE STEP DEVICE AND METHOD

(71) Applicant: Michael McGarey, El Mirage, AZ (US)

(72) Inventor: Michael McGarey, El Mirage, AZ (US)

(21) Appl. No.: 15/913,888

(22) Filed: Mar. 6, 2018

Related U.S. Application Data
(60) Provisional application No. 62/467,492, filed on Mar. 6, 2017.

(51) Int. Cl. E06C 7/02; G09F 13/16; E06C 7/00

(52) U.S. Cl. CPC E06C 7/02; E06C 7/003; G09F 13/16

(57) ABSTRACT

A portable step device is disclosed herein. The portable step device includes a step support surface with a top-side, the step support surface further having a surface-covering affixed to the top-side. The device also features a support rod having a length, a step-end, a base-end, a front-side and a back-side, where the support rod is fixed to the bottom-side of the step support surface and configured to elevate the step support surface away from a terrain. In addition, the device includes a base support surface having a support-rod side and a ground-side to provide stability for bracing the support rod and the step support surface on the terrain.

CROSS-REFERENCE TO RELATED APPLICATION(S)

The present application is related to and claims priority to U.S. Provisional Patent Application No. 62/467,492 filed Mar. 6, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of portable supports of existing art and more specifically relates to elevated foot stands.

### RELATED ART

Many kinds of stools are known such as those resembling a simple box or step, those with a flat platform supported by three or four legs, those mounted on wheels or casters which retract when loaded, and many others including more complex varieties with two or more steps which swing or fold out when in use. All of these may be stood upon to assist a person in reaching high places such as top shelves. However, heretofore all have been subject to one or more disadvantages. If the stool is a small, simple platform, a user may lose his balance unless something external is available to be grasped. Additionally, when it is to be moved, one must bend down and pick it up. If it is mounted on spring biased casters it may tend to roll when in use. If the stool has many steps, such as a small ladder, it may be awkward to move. Many portable steps are compact and sturdy by nature, but require the use of a corner or multiple abutments to support the device. A suitable solution is desired.

U.S. Pat. No. 8,628,143 to Kristin Wald relates to a corner-braced, portable, foot prop. The described corner-braced, portable, foot prop includes a corner-braced foot prop including a shelf and an angled support post resting on a base surface to support a load in an elevated position. The shelf includes a clearance hole through which the post is positioned and gripped by the clearance hole when the shelf rotates with respect to the post. The foot prop utilizes surrounding walls for lateral support while providing increasing stability when loaded by downward force.

### SUMMARY OF THE INVENTION

In view of the foregoing disadvantages inherent in the known portable supports art, the present disclosure provides a novel portable step device and method. The general purpose of the present disclosure, which will be described subsequently in greater detail, is to provide a vertical elevation support that is portable, compact, and may allow a user to gain height against a support surface.

A portable step device is disclosed herein. The portable step device may include a step support surface with a top-side, the step support surface further having a surface-covering affixed to the top-side. The device may also feature a support rod having a length, a step-end, a base-end, a front-side and a back-side, where the support rod is fixed to the bottom-side of the step support surface and configured to elevate the step support surface away from a terrain. In addition, the device may include a base support surface having a support-rod side and a ground-side to provide stability for bracing the support rod and the step support surface on the terrain.

According to another embodiment, a method for using a portable step device is also disclosed herein. The method for using the portable step device includes providing a portable step device, placing the portable step device on the terrain, and stepping on the step support surface.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable step device and method, constructed and operative according to the teachings of the present disclosure.

FIG. 1 is a perspective view of the portable step device during an ‘in-use’ condition, according to an embodiment of the disclosure.

FIG. 2 is a perspective view of the portable step device of FIG. 1, according to an embodiment of the present disclosure.

FIG. 3A shows a front view of the portable step device of FIG. 1, according to an embodiment of the present disclosure.

FIG. 3B shows another front view of the portable step device of FIG. 1, according to an embodiment of the present disclosure.

FIG. 4 is a lower perspective view of the portable step device of FIG. 1, according to an embodiment of the present disclosure.

FIG. 5 is a flow diagram illustrating a method of using a portable step device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to portable supports and more particularly to a portable step device and method as used to provide a vertical elevation support that is portable, compact, and may allow a user to gain height against a support surface.

Generally, the present invention may provide users with a small stepping tool assisting in gaining vertical height from 24″ to a maximum of 34″. It may utilize sanded grip tape on the stepping plate to prevent slips and falls while using the device. It may also include reflective tape covering the front side of the rod/shaft to improve safety in low-light conditions. The portable step device may support a weight load of up to 500 lbs. The device may also allow people to gain a better view of elevated surfaces, benefiting maintenance workers, mechanics, police officers, and much more.

The device may include a rod-shaped support with a stepping plate installed on the top portion, functioning as a tool to gain a vertical height advantage without the need for a ladder. The step support surface may be configured to be generally rectangular in shape and include rounded edges for safety. The step support surface may include a step surface area that may be less than 50 square inches. Similarly, the base portion (or bottom support plate) may be of a smaller surface area than the step support surface. The device may comprise a steel top step plate and a bottom support plate welded together by a hollow down rod. The top plate may be covered with rubber traction tape and rubber leading edge for slip protection. The surface-covering of the step support surface may include a tread that is structured and arranged to provide traction.

The hollow down rod may include an adjustment hole and can be covered in reflective tape to improve safety. The hollow down rod (support rod) may also be telescoping in configuration and allow for manual adjustment from approximately 24 inches to 34 inches. The bottom steel plate may consist of at least three different bases that include: rubber, spikes, and an extreme hook grip.

Users can place the device against a flat surface in order to stabilize the top and bottom plates. Leaning the device forward against a wall may stabilize the device, allowing individuals to safely step onto the top plate. The device may be useful for seeing inside a vehicle's front hood, over top hedges and other landscaping locations, and more. In addition, police officers can use the device to look over walls while being armed—this gives the officer view of a location without making a lot of noise.

The device can be constructed using steel, rubber, and other suitable materials. The top plate may measure approximately 6″ in length and 8″ in width. The down rod may measure approximately 27″ in height. The bottom plate may measure approximately 2″ in length and 6″ in width. Exact size, measurement, construction, and design specifications may vary upon manufacturing.

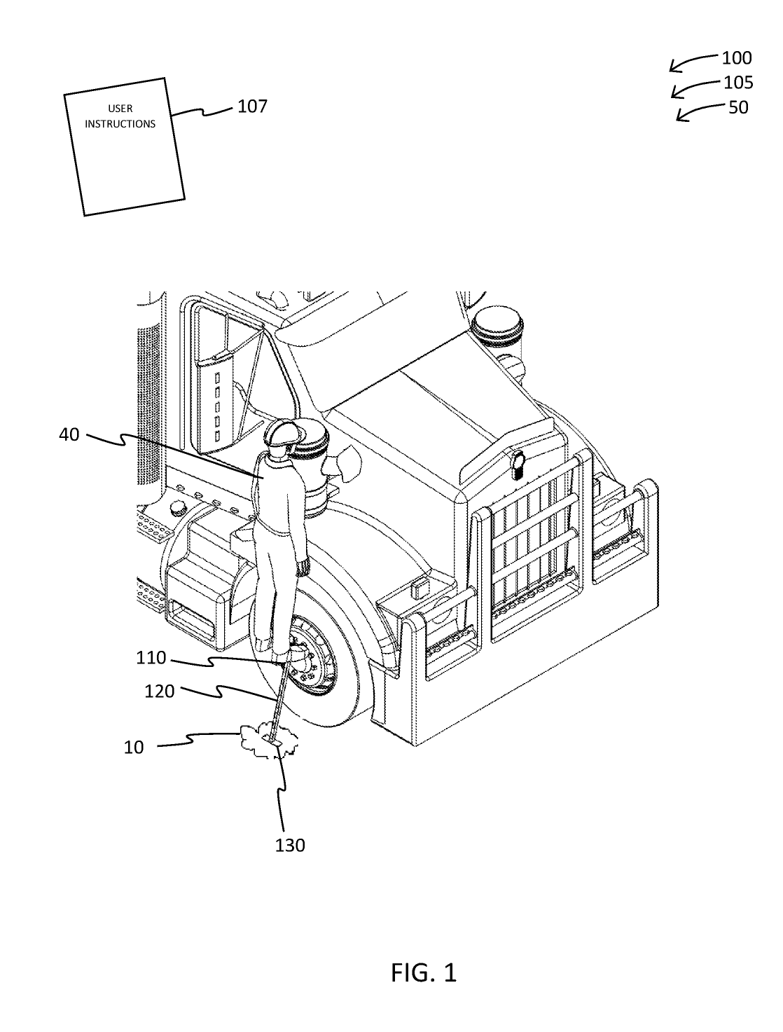

Referring now more specifically to the drawings by numerals of reference, there is shown in FIGS. 1-4, various views of a portable step device 100.

FIG. 1 shows a portable step device 100 during an ‘in-use’ condition 50, according to an embodiment of the present disclosure. Here, the portable step device 100 may be beneficial for use by a user 40 to provide a vertical elevation support that is portable, compact, and may allow a user to gain height against a support surface. As illustrated, the portable step device 100 may include a step support surface 110 connected with a support rod 120 and base support surface 130. The included support rod 120 may be configured to elevate the step support surface 110 away from a terrain 10.

According to one embodiment, the portable step device 100 may be arranged as a kit 105. In particular, the portable step device 100 may further include a set of instructions 107. The instructions 107 may detail functional relationships in relation to the structure of the portable step device 100 such that the portable step device 100 can be used, maintained, or the like, in a preferred manner.

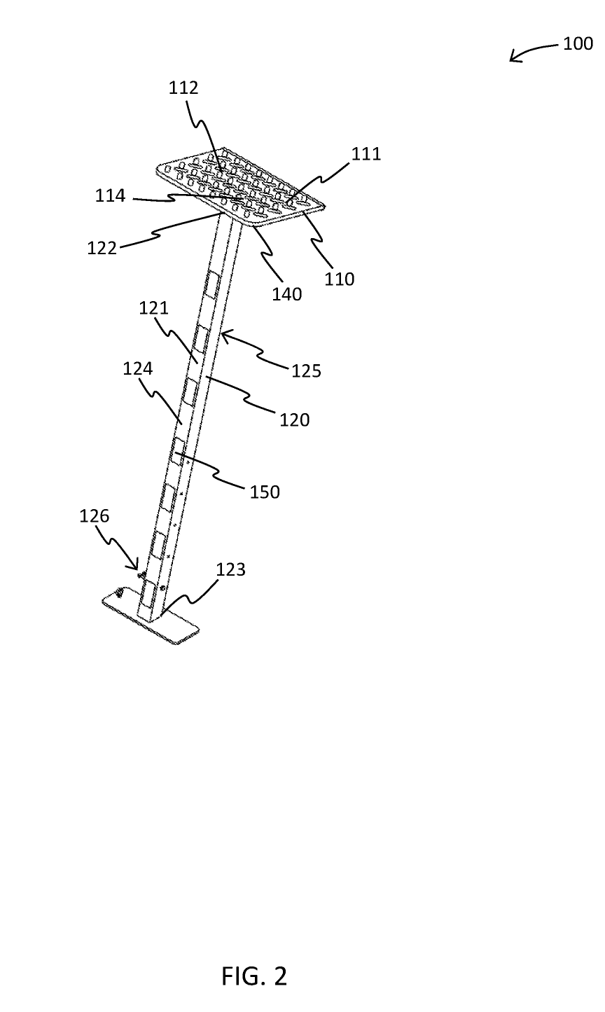

Referring now to FIG. 2 showing the portable step device 100 of FIG. 1, according to an embodiment of the present disclosure. As above, the portable step device 100 may include a step support surface 110 having a top-side 111 including a step surface area 112. The step support surface 110 may further include a pair of rounded edges 140 and a surface-covering 114 affixed to the top-side 111. The device may also feature a support rod 120 having a length 121, a step-end 122, a base-end 123, a front-side 124, a back-side 125, and a height-adjustment pin 126. The support rod 120 may feature a visual safety indicator 150 comprising reflective tape or another suitable element configured to alert the surrounding area to the presence of the device and a user.

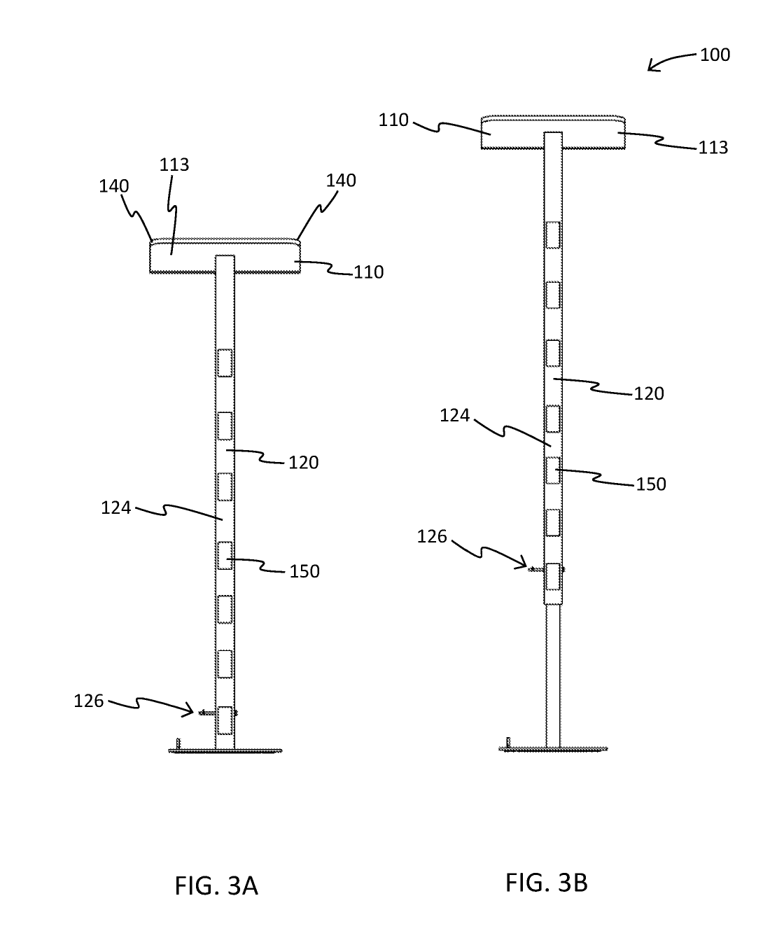

FIGS. 3A and 3B include front views of the portable step device of FIG. 1, according to an embodiment of the present disclosure. Here again, the portable step device 100 may include a step support surface 110 and a support rod 120 having a front-side 124, a visual safety indicator 150, and a height-adjustment pin 126. The step support surface 110 may also feature a bottom-side 113 and a pair of rounded edges 140.

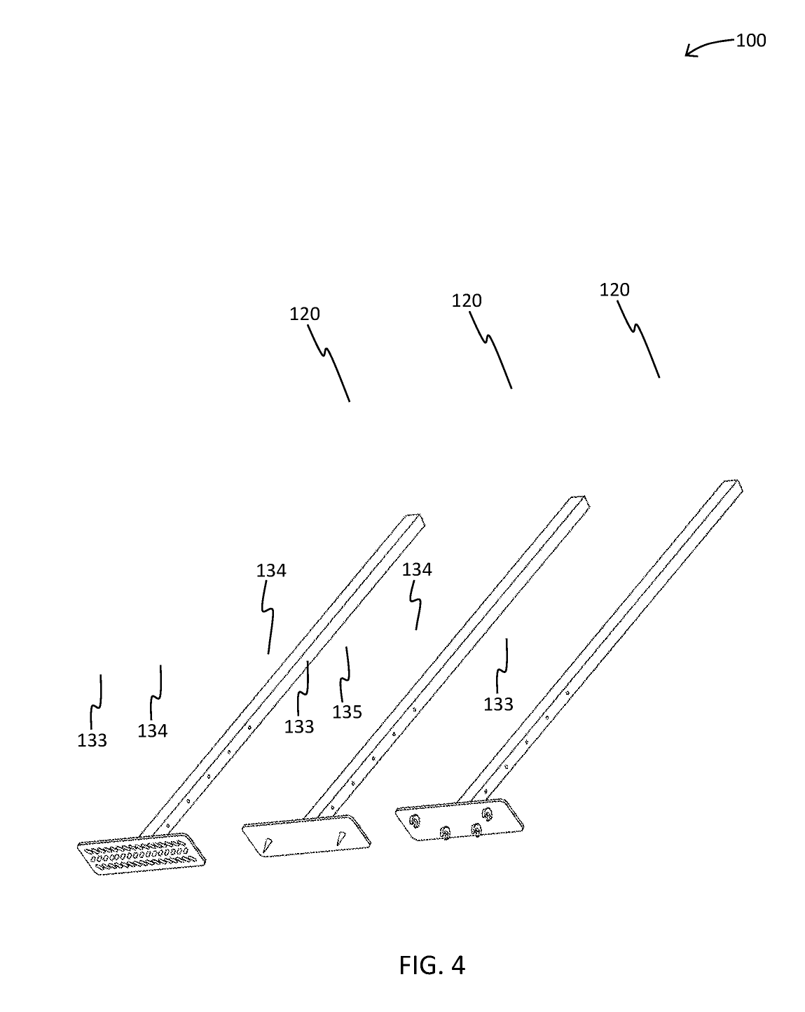

Referring now to FIG. 4 showing a lower perspective view of the portable step device of FIG. 1, according to an embodiment of the present disclosure. As above, the portable step device 100 may include a support rod 120 configured to telescopically adjust in varying heights. The support rod 120 may feature a base surface area 133 mechanically coupled to the support rod 120. The base surface area 133 may itself include at least one terrain-engaging member 134. In one embodiment, the at least one terrain-engaging member 134 may comprise at least one spike 135 configured to penetrate the terrain 10 when desired to promote positive-traction.

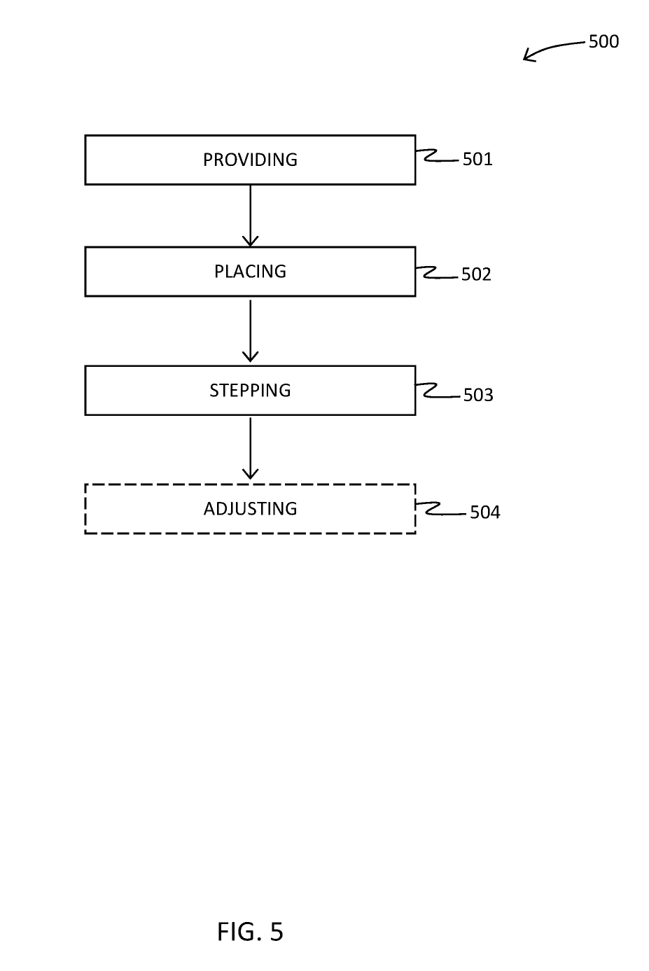

FIG. 5 is a flow diagram illustrating a method for using 500 a portable step device 100, according to an embodiment of the present disclosure. In particular, the method for using 500 a portable step device 100 may include one or more components or features of the portable step device 100 as described above. As illustrated, the method for using 500 a portable step device 100 may include the steps of: step one 501, providing a portable step device 100 including a step support surface having a top-side including a step surface area and a bottom-side, the step support surface further including a surface-covering affixed to the top-side, a support rod having a length, a step-end, a base-end, a front-side and a back-side, the support rod fixed to the bottom-side of the step support surface, the support rod configured to elevate the step support surface away from a terrain, and a base support surface having a support-rod side and a ground-side including a base surface area and at least one terrain-engaging member, the base support surface mechanically coupled to the support rod and configured to provide stability for bracing the support rod and the step support surface on the terrain; step two 502, placing the portable step device on the terrain; and step three 503, stepping on the step support surface for a designated task (those mentioned herein are exemplary).

It should be noted that step four 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for a portable step device 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable step device comprising:
a step support surface having a top-side including a step surface area and a bottom-side, the step support surface further including a surface-covering affixed to the top-side;
a support rod having a length, a step-end, a base-end, a front-side and a back-side, the support rod fixed to the bottom-side of the step support surface, the support rod configured to elevate the step support surface away from a terrain; and
a base support surface having a support-rod side and a ground-side including a base surface area and at least one terrain-engaging member, the base support surface mechanically coupled to the support rod and configured to provide stability for bracing the support rod and the step support surface on the terrain.

2. The portable step device of claim 1, wherein the step support surface includes a generally rectangular shape.

3. The portable step device of claim 2, wherein the generally rectangular shape includes a pair of rounded edges.

4. The portable step device of claim 1, wherein the surface-covering of the step support surface includes a tread structured and arranged to provide traction.

5. The portable step device of claim 4, wherein the surface-covering comprises rubber.

6. The portable step device of claim 1, wherein the step surface area of the step support surface is less than 50 square inches.

7. The portable step device of claim 1, wherein the base surface area is smaller than the step surface area.

8. The portable step device of claim 1, wherein the support rod includes a hollow center.

9. The portable step device of claim 1, wherein the support rod further includes a telescoping support member configured to mechanically extend from the hollow center.

10. The portable step device of claim 1, wherein the support rod comprises a height-adjustment pin configured to manually adjust the length of the support rod from 24 inches to 34 inches.

11. The portable step device of claim 1, wherein the at least one terrain-engaging member comprises a rubber tread.

12. The portable step device of claim 1, wherein the at least one terrain-engaging member comprises at least one spike configured to penetrate the terrain when desired to promote positive-traction.

13. The portable step device of claim 1, wherein the at least one terrain-engaging member comprises at least one hook-grip configured to mechanically couple with an object.

14. The portable step device of claim 1, wherein the support rod includes a visual safety indicator.

15. The portable step device of claim 14, wherein the visual safety indicator comprises reflective tape.

16. The portable step device of claim 1, wherein the support rod includes a decorative indicia.

17. A portable step device comprising:
a step support surface having a top-side including a step surface area and a bottom-side, the step support surface further including a surface-covering affixed to the top-side;
a support rod having a length, a step-end, a base-end, a front-side and a back-side, the support rod fixed to the bottom-side of the step support surface, the support rod configured to elevate the step support surface away from a terrain; and
a base support surface having a support-rod side and a ground-side including a base surface area and at least one terrain-engaging member, the base support surface mechanically coupled to the support rod and configured to provide stability for bracing the support rod and the step support surface on the terrain;
wherein the step support surface includes a generally rectangular shape;
wherein the generally rectangular shape includes a pair of rounded edges;
wherein the surface-covering of the step support surface includes a tread structured and arranged to provide traction;
wherein the surface-covering comprises rubber;
wherein the step surface area of the step support surface is less than 50 square inches;
wherein the base surface area is smaller than the step surface area;
wherein the support rod includes a hollow center;
wherein the support rod further includes a telescoping support member configured to mechanically extend from the hollow center;
wherein the support rod comprises a height-adjustment pin configured to manually adjust the length of the support rod from 24 inches to 34 inches;
wherein the at least one terrain-engaging member comprises a rubber tread;
wherein the at least one terrain-engaging member comprises at least one spike configured to penetrate the terrain when desired to promote positive-traction;
wherein the at least one terrain-engaging member comprises at least one hook-grip configured to mechanically couple with an object;
wherein the support rod includes a visual safety indicator;
wherein the visual safety indicator comprises reflective tape; and
wherein the support rod includes a decorative indicia.

18. The portable step device of claim 17, further comprising set of instructions; and
wherein the device is arranged as a kit.

19. A method for using a portable step device, the method comprising the steps of:
providing a portable step device including a step support surface having a top-side including a step surface area and a bottom-side, the step support surface further including a surface-covering affixed to the top-side, a support rod having a length, a step-end, a base-end, a front-side and a back-side, the support rod fixed to the bottom-side of the step support surface, the support rod configured to elevate the step support surface away from a terrain, and a base support surface having a support-rod side and a ground-side including a base surface area and at least one terrain-engaging member, the base support surface mechanically coupled to the support rod and configured to provide stability for bracing the support rod and the step support surface on the terrain;
placing the portable step device on the terrain; and
stepping on the step support surface.

20. The method of claim 19, further comprising the steps of:
adjusting a relative said length of the support rod to accommodate varying applications.
